(19) United States
(12) Patent Application Publication
(10) Pub. No.: US 2025/0188655 A1
(43) Pub. Date: Jun. 12, 2025

(54) INSULATING MATERIAL COMPRISING THERMOPLASTIC FIBERS, GLASS FIBERS AND A COUPLING AGENT

(71) Applicant: SAINT-GOBAIN ISOVER, COURBEVOIE (FR)

(72) Inventors: Vincent SENECHAL, COURBEVOIE (FR); Guillaume PAILLARD, COURBEVOIE (FR)

(21) Appl. No.: 18/729,122

(22) PCT Filed: Jan. 24, 2023
(86) PCT No.: PCT/FR2023/050092

§ 371 Date: Jul. 15, 2024

(30) Foreign Application Priority Data
Jan. 26, 2022 (FR) 2200664

(51) Int. Cl. D04H 1/4382; C03C 25/25; D04H 1/4218; D04H 1/4291; D04H 1/587; E04B 1/88

(52) U.S. Cl. CPC D04H 1/43835; C03C 25/25; D04H 1/4218; D04H 1/4291; D04H 1/43828; D04H 1/587; E04B 1/88; D10B 2401/04

(57) ABSTRACT

An insulating material includes glass fibers, at least one coupling agent and from 5% to 30% by weight of thermoplastic fibers relative to a total weight of the material.

### PRIOR ART

The present invention belongs to the field of thermal and/or acoustic insulating materials based on glass fibers, and on organic fibers. More specifically, the invention relates to durable composite insulating materials.

Composite materials are used in many fields. In the field of insulation, these materials generally comprise a mineral fiber matrix, responsible for giving the product the required properties such as satisfactory thermal properties, linked together by a binder, typically based on thermosetting polymers which gives the assembly a dimensional stability, a mechanical strength, and/or a homogeneous color. These polymers are easily implemented and have a good affinity for glass fibers.

However, as part of an ongoing search to improve the durability of materials, and in particular to reduce energy consumption and to achieve recyclability of the materials, thermosetting polymers are no longer satisfactory. Additionally, these polymers may also contain toxic components and emit volatile organic compounds during their handling.

Today, thermoplastic fibers are mainly used as a binder in the textile, health and hygiene industries. Solid thermoplastic binders represent an advantageous alternative to thermosetting liquid binders in order to reduce the water and energy consumption involved in the manufacture of insulating materials.

These binders also have the advantage of allowing, within the scope of an implementation in the manufacture of an insulating material, less heating compared to the hardening temperature of thermosets and complete recyclability of the insulating material.

However, since thermoplastic polymers are generally non-polar, they do not exhibit satisfactory adhesion to the mineral materials. Indeed, within an insulating material, these polymers adhere only to one another. As a result, they need to be implemented in large quantities in order to obtain mechanical properties such as those disclosed above which are satisfactory for an insulating material.

It is known from the prior art specific to other technical fields to produce thermoplastic materials reinforced using glass fibers.

In particular, the publications:
D. Bikiaris et al., Use of Silane Agents and Poly (propylene-g maleic anhydride) Copolymer as Adhesion Promoters in Glass Fiber/Polypropylene Composites, Journal of Applied Polymer Science, Vol. 81, 701-709 (2001),
D. Bikiaris et al, Use of Silanes and Copolymers as Adhesion Promoters in Glass Fiber/Polyethylene Composites, Journal of Applied Polymer Science, Vol. 80, 2877-2888 (2001), and
S. H. Pak et al, Acid-Base Interactions on Interfacial Adhesion and Mechanical Responses for Glass-Fiber-Reinforced Low-Density Polyethylene,
Journal of Applied Polymer Science, Vol. 65, 143-154 (1997) address polymeric matrices wherein glass fibers treated with silane are used as reinforcing agent.

CN 109023719 proposes polypropylene-based woven textile materials reinforced using glass fibers. This document mentions the modification of the glass fibers with silane as coupling agent.

US 2008/0142178 discloses fiber mats obtained by wet process containing glass filaments and polyvinyl alcohol or a copolymer of polyethylene terephthalate and mentions the use of a solution of coating the glass containing silane as coupling agent.

In the field of acoustic insulation, EP 1,659,382 proposes the use of a material comprising thermoplastic fibers, silane as coupling agent on aramid fibers used for their heat resistance.

To the inventors' knowledge, it has not been proposed to obtain an insulating material comprising thermoplastic fibers and glass fibers wherein the adhesion between said fibers makes it possible to achieve the desired mechanical properties according to the desired final insulating product.

There is therefore a need for a durable insulating material that can, however, have satisfactory mechanical properties on its implementation.

### OVERVIEW OF THE INVENTION

The present invention aims to remedy all or some of the disadvantages of the prior art, in particular those disclosed above, by proposing a solution that makes it possible to obtain an insulating material comprising thermoplastic fibers that have satisfactory adhesion with the glass fibers that make up said insulating material.

To this end, and according to a first aspect, the invention relates to an insulating material comprising glass fibers, at least one coupling agent and from 5% to 30% by weight of thermoplastic fibers relative to the total weight of the material.

Such a material according to the invention is of interest, in particular, due to the fact that it is completely recyclable, does not require any water consumption and involves weak heating while being satisfactory for use in the field of insulation in view of its mechanical properties, in particular of adhesion of the thermoplastic fibers and of the glass fibers to one another.

The term “glass fibers” is intended to denote fibers included in glass wools, rock wools and slag wools. Such fibers are for example disclosed in patents EP 1,032,542, EP 1,522,532 and EP 0,399,320.

The glass fibers according to the invention may have the following composition, expressed by weight relative to the total weight of the glass fiber:
SiO₂ from 50 to 75%, preferably from 60 to 70%,
Na₂O from 10 to 25%, preferably from 10 to 25%,
CaO from 5 to 15%, preferably from 5 to 10%,
MgO from 1 to 10%, preferably from 2 to 5%, CaO and MgO together preferably representing from 5 to 20%,
B₂O₃ from 0 to 10%, preferably from 2 to 8%,
Al₂O₃ from 0 to 8%, preferably from 1 to 6%,
K₂O from 0 to 5%, preferably between 0.5 and 2%, Na₂O and K₂O together preferably representing between 12 and 20%,
Iron oxides from 0 to 3%, preferably less than 2%, also preferably less than 1%, and
other oxide(s) from 0 to 5% by weight cumulatively, preferably less than 3% by weight cumulatively, the remainder consisting of unavoidable impurities,
The glass fibers according to the invention may also have the following composition, usually found in the rock wool, expressed by weight relative to the total weight of the glass fiber:
SiO₂ from 30 to 50%, preferably from 35 to 45%,
Na₂O from 0 to 10%, preferably from 0.4 to 7%,
CaO from 10 to 35%, preferably from 12 to 25%,
MgO from 1 to 15%, preferably from 5 to 13%, CaO and MgO together preferably representing from 11 to 40%,
Al₂O₃ from 10 to 27%,
K₂O from 0 to 2%, preferably from 0 to 1%,
Iron oxides from 0.5 to 15%, preferably from 3% to 12%, and
other oxide(s) from 0 to 5% by weight cumulatively, preferably less than 3% by weight cumulatively,
   the remainder consisting of unavoidable impurities,
Within the meaning of the present invention, “coupling agent” is understood to denote:
Either an organofunctional silane with which the glass fibers of the material according to the invention are treated,
Or a polar coupling agent, comprised in the thermoplastic fibers of the material according to the invention.

An insulating material according to the invention, containing at least one coupling agent, therefore comprises an organofunctional silane on the surface of its glass fibers and/or a polar coupling agent in its thermoplastic fibers.

According to the present invention, a polar coupling agent is a chemical compound bearing a polar functional group, able to be introduced into the thermoplastic fibers of a material according to the invention.

Thus, the polar coupling agent suitable for the present invention may be chosen from anhydrides, acids and organofunctional silanes, in particular the polar coupling agent is selected from anhydrides, acids and organofunctional silanes with amine or epoxy functions, preferably the polar coupling agent is selected from maleic anhydride, maleic acid and (3-aminopropyl)triethoxysilane (APTES).

Within the meaning of the invention, an organofunctional silane is a compound of formula (I)

(R′O)₃₋ₙSi(R″)ₙ—R (I)

where
n is an integer selected from 1, 2, and 3,
each R′ is independently selected from the group consisting of a hydrogen atom, C₁-C₈ alkyls and C₁-C₈ acyls.
each R″ is independently selected from C₁-C₈ alkyls, and
R is a carbon chain having an organic functional group

In particular, R is a carbon chain having a functional group selected from amine, vinyl, epoxy, (meth)acrylic, sulfide, alkyl and phenyl functional groups.

For the purposes of the invention, “(meth)acrylic functions” are alternatively understood to mean methacrylic and acrylic functions.

According to a preferred embodiment of the invention, when the thermoplastic fibers comprise a polar coupling agent, R is a carbon chain having a functional group selected from amine, epoxy, (meth)acrylic, sulfide functional groups.

In a particular embodiment of the invention, and depending on the nature of the carbon chain R, the organofunctional silane used is then an alkyl alkoxysilane optionally having an amine, vinyl, epoxy, (meth)acrylic, sulfide or phenyl functional group.

Among the organofunctional silanes comprising an alkyl functional group which are suitable for the invention, mention may be made especially of ethyltriacetoxysilane and methyltriacetoxysilane

Among the organofunctional silanes comprising an amine functional group which are suitable for the invention, mention may be made especially of (3-aminopropyl)triethoxysilane (APTES), 3-aminopropyltrimethoxysilane, 3-aminopropylmethyldiethoxysilane, N-(2-aminoethyl)-3-aminopropyl-trimethoxysilane, N-(n-butyl)-3-aminopropyltrimethoxysilane and N-benzyl-N′-(3-trimethoxysilyl)-1,2-ethylenediamine.

Among the organofunctional silanes comprising a vinyl functional group which are suitable for the invention, mention may be made especially of vinyltrimethoxysilane and vinyltriethoxysilane.

Among the organofunctional silanes comprising an epoxy functional group which are suitable for the invention, mention may be made especially of (3-glycidyloxypropyl)trimethoxysilane (GLYMO) and (3-glycidyloxypropyl)trimethoxysilane (GLYEO).

Among the organofunctional silanes comprising a (meth)acrylic functional group which are suitable for the invention, mention may be made especially of 3-methacryloxypropyltrimethoxysilane and (3-acryloxypropyl)trimethoxysilane.

Among the organofunctional silanes comprising a sulfide functional group which are suitable for the invention, mention may be made especially of (3-mercaptopropyl)trimethoxysilane.

Among the organofunctional silanes comprising a phenyl functional group which are suitable for the invention, mention may in particular be made of N-benzyl-N′-(3-trimethoxysilyl)-1,2-ethylenediamine.

According to one embodiment of the invention, the organofunctional silane used according to the invention is selected from (3-aminopropyl)triethoxysilane, (3-glycidyloxypropyl)trimethoxysilane and 3-methacryloxypropyltrimethoxysilane. Preferably, the organofunctional silane used according to the invention is (3-aminopropyl)triethoxysilane.

According to another embodiment of the invention, R is selected from C₁-C₈ glycidyloxyalkyls and C₁-C₈ aminoalkyls.

In a particular embodiment of the invention, the glass fibers are treated with an organofunctional silane selected from the organofunctional silanes with an amine functional group and the organofunctional silanes with epoxy functional group, in particular the glass fibers are treated with an organofunctional silane selected from (3-aminopropyl)triethoxysilane, (3-glycidyloxypropyl)trimethoxysilane and 3-methacryloxypropyltrimethoxysilane and preferably the glass fibers are treated with (3-aminopropyl)triethoxysilane (APTES).

According to a second aspect, the invention relates to an acoustic and/or thermal insulating product, obtained from an insulating material according to the invention.

According to a third aspect, the invention relates to a process for manufacturing an insulating material according to the invention, comprising a first step of mixing the thermoplastic fibers and the glass fibers and then a heating step.

The thermoplastic fibers used according to the invention may be selected from fibers of polyolefin, polyethylene terephthalate (PET), poly (vinyl chloride) (PVC), polyvinyl butyral (PVB), polystyrene (PS), polyurethane (PU), polyamide (PA) and copolymers thereof, in particular thermoplastic fibers are selected from fibers of polyolefin, PET and copolymers thereof, preferably the thermoplastic fibers are selected from fibers of polypropylene (PP), polyethylene (PE) and copolymers thereof.

In one embodiment, the thermoplastic fibers consist of a thermoplastic phase as defined above.

In another embodiment of the invention, the thermoplastic fibers are said to be “bi-component,” that is, they consist of at least two distinct phases of thermoplastics as defined above. For example, a thermoplastic fiber implemented according to this embodiment may consist of a core and a sheath or else of two continuous phases of juxtaposed thermoplastics. The methods for obtaining such fibers are known to a person skilled in the art and are for example disclosed in U.S. Pat. No. 4,406,850 and EP 0,011,954. Such fibers are also commercially available and for example constitute the fabric sold under the name FELIBENDY by Kuraray Kuraflex.

This embodiment makes it possible to select two phases having distinct melting temperatures in order, during the process for manufacturing the insulating material, to heat to a temperature higher than the melting point of a first phase but lower than that of a second phase, so that the thermoplastic fibers retain a certain structural integrity.

According to this embodiment, the polar coupling agent can be comprised in a single phase of the thermoplastic fibers. In particular, when the thermoplastic fibers consist of a core and a sheath, the polar coupling agent is comprised in the phase that constitutes the sheath of the thermoplastic fibers.

An insulating material as disclosed in the present text may contain from 1% to 70% by weight of thermoplastic fibers, in particular from 3% to 50% by weight of thermoplastic fibers, and preferably from 5% to 30% by weight of thermoplastic fibers relative to the total weight of the insulating material.

An insulating material according to the invention comprises from 5% to 30% by weight of thermoplastic fibers relative to the total weight of the insulating material.

The thermoplastic fibers used in an insulating material according to the invention may have a count of from 0.8 dtex to 4 dtex, in particular from 0.9 dtex to 3 dtex and preferably from 1 dtex to 1.5 dtex.

The fiber count is conventionally used in the textile industry; it refers to the mass in grams of 1000 meters of a fiber. The count is expressed in tex (1 tex=10-6 kg/m) or, more typically, in dtex (1 dtex=0.1 tex).

The thermoplastic fibers implemented in an insulating material according to the invention may also have a length of from 2 mm to 100 mm, in particular from 3 mm to 60 mm, and preferably from 6 mm to 20 mm.

As shown in the examples below, the inventors have also observed that the adhesion of the glass fibers and thermoplastic fibers to one another in an insulating material according to the invention is significantly increased by the presence of polar chemical functions in the thermoplastic fibers.

These functions can be introduced either by mixing a polar coupling agent in the thermoplastic fibers or by copolymerization of thermoplastics with polar monomer units.

Thus, according to one embodiment, the at least one coupling agent present in an insulating material according to the invention is a polar coupling agent comprised in the thermoplastic fibers of said material that are present.

According to this embodiment, the polar coupling agent may be selected from anhydrides, acids and organofunctional silanes, in particular the polar coupling agent is selected from anhydrides, acids and organofunctional silanes with amine or epoxy functions, preferably the polar coupling agent is selected from maleic anhydride, maleic acid and (3-aminopropyl)triethoxysilane (APTES).

Such thermoplastic fibers may be obtained according to methods known to a person skilled in the art and disclosed for example in applications U.S. Ser. No. 09/056,875 and WO 2009/051283 A1.

According to another embodiment, the thermoplastic fibers present in an insulating material according to the invention comprise polar monomer units.

According to this embodiment, the polar monomer units are monomeric units of polyvinyl alcohol.

For example, the thermoplastic fibers implemented in an insulating material according to the invention may comprise an ethylene-vinyl alcohol (EVOH) copolymer.

Such thermoplastic fibers can be obtained according to methods known to a person skilled in the art and are, for example, present in the fabric sold by Kuraray Kuraflex under the name FELIBENDY.

An insulating material according to the invention may have a basis weight of from 400 g/m² to 12,000 g/m², in particular from 500 g/m² to 8,000 g/m² and preferably from 600 g/m² to 4,000 g/m².

An insulating material according to the invention may have a thickness of from 10 mm to 300 mm, in particular from 15 mm to 200 mm and preferably from 20 mm to 100 mm.

An insulating material according to the invention may have a thermal conductivity of from 0.025 W/m·K to 0.050 W/m·K, in particular from 0.028 W/m·K to 0.048 W/m·K and preferably from 0.030 W/m·K to 0.045 W/m·K.

These thermal conductivity values are obtained by measurements in accordance with standards NF-EN-12667 and NF-EN-12939.

The invention also relates to an acoustic and/or thermal insulating product comprising an insulating material according to the invention.

Such a product is provided in particular in the form of rolls or panels.

It can be employed, for example, in buildings, in industry or in means of transportation, in particular rail or shipping. The product according to the invention can be employed to thermally insulate any type of buildings, tertiary sector buildings or living quarters (multi-unit or individual). It can, for example, be used in systems for insulating via the outside, for the insulation of wooden-framed houses, in sandwich panels, in ventilation ducts, etc.,

The invention also relates to a process for manufacturing an insulating material according to the invention, comprising a first step of mixing the thermoplastic fibers and the glass fibers and then a heating step.

The heating step of a method according to the invention may comprise heating at a temperature of 90° C. to 260° C., in particular of 100° C. to 250° C. and preferably of 110° C. to 240° C.

In the embodiment wherein the thermoplastic fibers are said to be “bi-component,” the temperature of the heating step is chosen in particular based on the melting temperatures of the components. Thus, the temperature of the heating step is preferably greater than the melting temperature of a first phase of the thermoplastic fiber and less than the melting temperature of a second phase of the thermoplastic fiber.

The following examples nonlimitingly illustrate the invention.

### EXAMPLES

In order to measure the adhesion between the thermoplastic fibers and the glass fibers, samples of these materials are prepared. For each measurement, three glass plates, conventionally used for observation with a microscope of samples and a polymeric mat composed of fibers consisting of a polypropylene core and a polyethylene sheath, are used.

The polymeric mat can be obtained from the FELIBENDY commercial compound sold by Kuraray Kuraflex. The mats used in the examples below have a thickness of from 0.1 mm to 1 mm as well as a basis weight of about 140 g/m².

The glass plates are cleaned with water and then ethanol, and any organic residues are removed using the flame of a burner.

For each measurement, the samples are obtained by placing them vertically according to 3 layers:
a first layer consisting of two glass plates, an upper plate and a lower plate, adjacent by their widths,
a second layer consisting of the polymeric web, partially covering the glass plates of the first layer so as to overlap them, and
a third layer consisting of a glass plate, covering the polymeric mat of the second layer.

The samples thus obtained undergo a firing step in an oven for 10 min at 140° C.

The adhesion between the materials is then measured using a universal testing machine, with reference Instron 5965L9952, 2580/2 kN cell, moving the upper plate, engaged in the moving jaw of the machine at a speed of 2 mm/min. The measured maximum force is considered to be the breaking force of the system.

Table 1 below shows the various systems studied as well as the average breaking forces measured for each of them, measured during four tests.

TABLE 1

| | Example 1 | Example 2 | Example 3 | |
|---|---|---|---|---|
| | according | according | according | Compar- |
| | to the | to the | to the | ative |
| | invention | invention | invention | example 4 |
| Surface | Yes | No | Yes | No |
| Treatment of the | | | | |
| glass with | | | | |
| organofunctional | | | | |
| silane | | | | |
| Presence of a | No | Yes | Yes | No |
| coupling agent in | | | | |
| the polymeric web | | | | |
| Breaking strength | 215 ± 81 | 200 ± 31 | 470 ± 46 | 90 ± 13 |
| (N) | | | | |

For examples 1 and 3 according to the invention, the surface treatment of the glass with the organofunctional silane is carried out after the cleaning steps (3-disclosed above using a paper soaked with aminopropyl)triethoxysilane (APTES), passed over the surface of the glass plates, then brought into contact with the polymeric mat.

For examples 2 and 3 according to the invention, a polymeric mat further comprising maleic anhydride dispersed in the thermoplastic fibers is used.

By comparing the breaking forces measured for example 1 according to the invention with those of comparative example 4 or by comparing the breaking forces measured for example 3 according to the invention with those of example 2 according to the invention, it clearly appears that the surface treatment of the glass with the organofunctional silane, here the APTES, makes it possible to significantly improve the adhesion of glass substrates and thermoplastic fibers to one another.

In addition, by comparing the breaking forces measured for example 2 according to the invention with those of comparative example 4, it also appears that the presence of a polar coupling agent, here maleic anhydride, in the thermoplastic fibers makes it possible to significantly improve the adhesion of glass substrates and thermoplastic fibers to one another.

Additionally, it should also be noted that, for example 3 according to the invention, it is not possible to disassemble the glass plates and the polymeric mat without breaking the glass. Indeed, the breakage occurs within the thermoplastic mat and not at the interface with the glass plates. The measured breaking force is then only representative of the cohesion of the polymeric mat and not of the adhesion of said polymeric mat to the glass plates. The breaking force representative of the adhesion between the polymeric mat and the glass plates is therefore in reality higher than the measured breaking force. It is thus demonstrated that the combined presence of coupling agents in the form of an organofunctional silane used in the surface treatment of glass substrates and of a polar coupling agent present in the thermoplastic fibers also makes it possible to greatly improve this adhesion.

In conclusion, the results presented in Table 1 above therefore demonstrate that a coupling agent allows a significant increase in the adhesion of glass substrates with thermoplastic fibers. This coupling agent may take the form of an organofunctional silane introduced by surface treatment of a glass substrate or a polar coupling agent present in the thermoplastic fibers. In particular, the adhesion is maximal when an organofunctional silane introduced by surface treatment of the glass and a polar coupling agent in the thermoplastic fibers are present as coupling agents.

1. An insulating material comprising glass fibers, at least one coupling agent and from 5% to 30% by weight of thermoplastic fibers relative to a total weight of the material.

2. The insulating material according to claim 1, wherein the at least one coupling agent is an organofunctional silane with which the glass fibers are treated.

3. The insulating material according to claim 1, wherein the at least one coupling agent is a polar coupling agent comprised in the thermoplastic fibers.

4. The insulating material according to claim 3, wherein the polar coupling agent is selected from anhydrides, acids and organofunctional silanes.

5. The insulating material according to claim 1, wherein the thermoplastic fibers comprise polar monomer units.

6. The insulating material according to claim 5, wherein the polar monomer units are monomer units of polyvinyl alcohol.

7. The insulating material according to claim 1, wherein the thermoplastic fibers are selected from fibers of polyolefin, polyethylene terephthalate (PET), poly (vinyl chloride) (PVC), polyvinyl butyral (PVB), polystyrene (PS), polyurethane (PU), polyamide (PA) and copolymers thereof.

8. The insulating material according to claim 1, having a thermal conductivity of from 0.025 W/m·K to 0.050 W/m·K.

9. The insulating material according to claim 1, wherein the thermoplastic fibers have a count of from 0.8 dtex to 4 dtex.

10. The insulating material according to claim 1, wherein the thermoplastic fibers have a length of from 2 mm to 100 mm.

11. The insulating material according to claim 2, wherein the glass fibers are treated with an organofunctional silane selected from the organofunctional silanes with an amine functional group and the organofunctional silanes with epoxy functional group.

12. The insulating material according to claim 1, having a basis weight of from 400 g/m² to 12,000 g/m².

13. The insulating material according to claim 1, having a thickness of from 10 mm to 300 mm.

14. An acoustic and/or thermal insulating product comprising an insulating material according to claim 1.

15. A process for manufacturing an insulating material according to claim 1, comprising mixing the thermoplastic fibers and the glass fibers and then a heating step.

16. The insulating material according to claim 4, wherein the polar coupling agent is selected from anhydrides, acids and organofunctional silanes with amine or epoxy functions.

17. The insulating material according to claim 16, wherein the polar coupling agent is selected from maleic anhydride, maleic acid and (3-aminopropyl)triethoxysilane (APTES).

18. The insulating material according to claim 7, wherein the thermoplastic fibers are selected from fibers of polyolefin, PET and copolymers thereof.

19. The insulating material according to claim 18, wherein the thermoplastic fibers are selected from fibers of polypropylene (PP), polyethylene (PE) and copolymers thereof.

20. The insulating material according to claim 8, having a thermal conductivity of from 0.028 W/m·K to 0.048 W/m·K.
